(19) United States
(12) Patent Application Publication
(10) Pub. No.: US 2016/0092874 A1
(43) Pub. Date: Mar. 31, 2016

(54) METHOD AND SYSTEM FOR CONDUCTING PRE-AUTHORIZED FINANCIAL TRANSACTIONS

(71) Applicant: VISA INTERNATIONAL SERVICE ASSOCIATION, San Francisco, CA (US)

(72) Inventors: Alan Joseph O'Regan, Cape Town, Western Cape Province (ZA); Horatio Nelson Huxham, Cape Town, Western Cape Province (ZA)

(21) Appl. No.: 14/782,146

(22) PCT Filed: Apr. 4, 2014
(86) PCT No.: PCT/IB2014/060436

§ 371 Date: Oct. 2, 2015

(30) Foreign Application Priority Data
Apr. 4, 2013 (ZA) 2013/02416

(51) Int. Cl. G06Q 20/40; G06Q 20/32

(52) U.S. Cl. CPC G06Q 20/40; G06Q 20/407; G06Q 20/322

(57) ABSTRACT

A method and system for conducting a pre-authorized financial transaction is disclosed. A security gateway receives a pre-authorization token and a consumer alias from a merchant or an acquirer of the merchant. The token identifies a pre-authorized financial transaction and the token and alias have previously been provided to the merchant by a consumer. The alias is matched with a stored alias to identify an electronic device of the consumer. An authorization request is transmitted to the electronic device. A confirmation message or a denial message is received by the security gateway in response to the authorization request. Upon receiving a confirmation message, payment credentials associated with a selected payment instrument of the consumer and required for conducting the pre-authorized transaction are transmitted to the merchant or the acquirer of the merchant for use in completing the transaction.

### CROSS-REFERENCE TO RELATED APPLICATION

This application claims priority to South African provisional patent application number 2013/02416 entitled “Pre-Authorized payment system and method”, filed on 4 Apr. 2013, which is incorporated by reference herein.

### BACKGROUND

Pre-authorization is commonly used to conduct financial transactions. In many cases, a pre-authorized payment is employed to conduct a direct debit transaction, also known as a “pre-authorized debit”, “debit order” or “bill payment”.

Direct debit transactions differ from direct deposit transactions and standing order transactions in that the transaction to be carried out is initiated by a payee or its acquiring bank and not by a payor.

In the case of a direct debit transaction, the payee or an acquiring entity of the payee withdraws funds from a bank account of the payor. The payee is typically a merchant, while the payor is typically a consumer. The merchant instructs its acquiring bank to collect funds directly from a bank account initially designated by the consumer. These funds are then transferred from the bank account of the consumer to a bank account designated by the merchant.

Before an issuing bank of the consumer allows the transaction to take place, the issuing bank may confirm that the merchant or the acquiring bank of the merchant is authorized to directly withdraw the funds. After the necessary authorities are set up, direct debit transactions may often be automatically processed by an electronic payment system.

Direct debit transactions are commonly used to carry out recurring financial transactions. The payment amounts may be fixed, such as loan installments or rental fees, or variable, such as credit card bills and utility bills. However, direct debit transactions in the form of pre-authorized payments can also be used for irregular or once-off payments, such as for mail order transactions or for point of sale (POS) transactions.

A disadvantage of existing methods of conducting a pre-authorized transaction is that, in many cases, the merchant may capture or otherwise be exposed to payment credentials of the consumer. The payment credentials may, for example, include a bank account number, a payment card expiry date and/or a card verification value (CVV). This may lead to fraudulent activities on the part of the merchant or other entities obtaining access to the payment credentials.

A further drawback of pre-authorized transactions is that, once set up, modifying the details of the transaction may be difficult or cumbersome. Administrative steps required for modifying, for example, the payment amount, the date of the payment, or the selected bank account to debit, may be time-consuming. It may also be time-consuming and/or relatively complex to cancel a pre-authorized transaction of the type described above.

In addition to the above-mentioned disadvantages, there is also a risk that a pre-authorization mechanism may be inappropriately used by the merchant to deduct funds from the bank account of the consumer. For example, an amount greater than an agreed-upon amount may be deducted or recurring payments may occur more frequently than initially agreed upon between the consumer and the merchant.

Furthermore, when the consumer has chosen to use a credit card or debit card account for pre-authorized payments, it may be the case that the acquiring bank processes the payments as card not present (CNP) type transactions, which may incur significantly higher interchange fees or other banking fees when compared to card-present type transactions.

There is thus a need for simplifying and/or expediting the process of modifying details of a pre-authorized transaction, or cancelling a pre-authorized transaction. A need also exists for conducting pre-authorized transactions without being required to present or transmit the payment credentials of the consumer to the merchant. Finally, there exists a need for reducing the risk that pre-authorized transaction mechanisms may be inappropriately used to deduct funds from the bank account of a consumer.

The present invention aims to address these problems, at least to some extent.

### SUMMARY OF THE INVENTION

In accordance with the invention there is provided a method of conducting a pre-authorized financial transaction, the method carried out at a security gateway and comprising: receiving a pre-authorization token and a consumer alias from a merchant or an acquirer of the merchant, the pre-authorization token identifying a pre-authorized financial transaction and the token and alias having previously been provided to the merchant by a consumer; identifying an electronic device of the consumer corresponding to the alias by matching the alias with an alias stored in association with a consumer record; transmitting an authorization request to the electronic device; receiving from the electronic device either a confirmation message or a denial message in response to the authorization request; in response to receiving a confirmation message, transmitting payment credentials associated with a selected payment instrument of the consumer and required for conducting the pre-authorized transaction to the merchant or the acquirer of the merchant for use in completing the transaction; and in response to receiving a denial message, transmitting a denial notification to the merchant or the acquirer of the merchant.

Further features of the invention provide for the pre-authorization token to be generated by the electronic device of the consumer; and for the method to further comprise the steps of: receiving a request from the electronic device to cancel the pre-authorized financial transaction identified by the pre-authorization token or to alter details of the financial transaction, and either cancelling the financial transaction or altering details of the financial transactions based on the request received from the electronic device.

Yet further features of the invention provide for the authorization request to include details of the financial transaction, including one or more of: a payment amount, a date of payment, merchant information, and a selected payment instrument; and for the financial transaction to be a direct debit transaction in which the acquirer of the merchant withdraws funds in favor of the merchant from a financial account of the consumer associated with the selected payment instrument.

Still further features of the invention provide for the financial transaction to be a once-off payment; and for the financial transaction to be either one of a mail or telephone order transaction or a point-of-sale (POS) transaction.

Further features of the invention provide for the financial transaction to be a recurring payment; for the pre-authorization token to remain valid for each recurring payment; for the confirmation message received from the electronic device of the consumer to include an instruction indicating a selected payment instrument; and for the confirmation message received from the electronic device of the consumer to include the payment credentials required for conducting the pre-authorized transaction.

Yet further features of the invention provide for the alias to be any one of a Mobile Subscriber Integrated Services Digital Network Number (MSISDN), an e-mail address of the consumer, a unique name, a unique identification number, or a unique set of personal information of the consumer; and for completion of the pre-authorized financial transaction to result in at least one bank account held by the consumer to be debited and at least one bank account held by the merchant to be credited.

The invention extends to a method of conducting a pre-authorized financial transaction, the method carried out at an electronic device of a consumer and comprising: generating a pre-authorization token which identifies a pre-authorized financial transaction, the token being generated such that the consumer is capable of providing the token and a consumer alias to a merchant for onward transmission to a security gateway, the security gateway matching the alias with an alias stored in association with a consumer record to identify the electronic device of the consumer; receiving an authorization request from the security gateway; and transmitting to the security gateway either a confirmation message or a denial message in response to the authorization request.

Further features of the invention provide for the method to include the step of receiving, by input of the consumer, either an instruction to alter details relating to the financial transaction identified by the pre-authorization token or an instruction to cancel the financial transaction; for the instruction to alter details relating to the financial transaction to include a selection of a payment instrument to link to the pre-authorization token; and for the instruction to alter details relating to the financial transaction or the instruction to cancel the financial transaction to be received at the electronic device after the pre-authorization token has been provided to the merchant.

Still further features of the invention provide for the authorization request received from the security gateway to prompt the consumer confirm or deny the pre-authorized transaction; and for the step of transmitting to the security gateway either a confirmation message or a denial message in response to the authorization request to be preceded by the step of: using a predefined authorization setting to determine whether to confirm or deny the pre-authorized transaction, and generating a confirmation message or a denial message in accordance with the predefined authorization setting.

Yet further features of the invention provide for the payment credentials to be stored on the electronic device in an encrypted format; for the confirmation message to include the payment credentials required for conducting the pre-authorized transaction; and for more than one set of payment credentials to be stored on the electronic device, each set of payment credentials corresponding to a different payment instrument of the consumer.

Even further features of the invention provide for the electronic device to be a mobile phone; and for the selected payment instrument to represent a mobile banking account.

The invention extends to a system for conducting a pre-authorized financial transaction, comprising a security gateway including: a token receiving component for receiving a pre-authorization token and a consumer alias from a merchant or an acquirer of the merchant, the pre-authorization token identifying a pre-authorized financial transaction and the token and alias having previously been provided to the merchant by a consumer; an identifying component for identifying an electronic device of the consumer corresponding to the alias by matching the alias with an alias stored in association with a consumer record; a transmitting component for transmitting an authorization request to the electronic device; an authorization component for receiving from the electronic device either a confirmation message or a denial message in response to the authorization request; and wherein, in response to receiving a confirmation message, the transmitting component transmits payment credentials associated with a selected payment instrument of the consumer and required for conducting the pre-authorized transaction to the merchant or the acquirer of the merchant for use in completing the transaction; and in response to receiving a denial message, the transmitting component transmits a denial notification to the merchant or the acquirer of the merchant.

Further features of the invention provide for the system to further comprise an electronic device of a consumer including: a token generating module for generating the pre-authorization token such that the consumer is capable of providing the token to the merchant; a request receiving component for receiving the authorization request from the security gateway; and a transmitting component for transmitting either the confirmation message or the denial message to the security gateway in response to the authorization request.

A further feature of the invention provides for the electronic device to further include one or both of a token modification module for altering details of the financial transaction identified by the pre-authorization token and a token deletion module for cancelling the financial transaction after the pre-authorization token has been provided to the merchant.

Still further features of the invention provide the payment credentials to be stored in a secure element associated with the electronic device; and for the secure element to be a hardware security module (HSM) or include a HSM.

Further features of the invention provide for the secure element to be a HSM embedded in the electronic device; alternatively, for the secure element to be a removable HSM; and for the secure element to be a secure element in a Universal Integrated Circuit Card (UICC) of the electronic device.

Yet further features of the invention provide for the HSM to be attached to a communication component of the electronic device; and for the HSM to be part of a cryptographic expansion device attached to a communication component of the electronic device, the HSM having a public processing unit and a secure processing unit, the secure processing unit being accessible by the communication component and/or the electronic device only through the public processing unit.

The invention extends to a computer program product for conducting pre-authorized financial transactions, the computer program product comprising a computer-readable medium having stored computer-readable program code for performing the steps of: receiving a pre-authorization token and a consumer alias from a merchant or an acquirer of the merchant, the pre-authorization token identifying a pre-authorized financial transaction and the token and alias having previously been provided to the merchant by a consumer; identifying an electronic device of the consumer corresponding to the alias by matching the alias with an alias stored in association with a consumer record; transmitting an authorization request to the electronic device; receiving from the electronic device either a confirmation message or a denial message in response to the authorization request; in response to receiving a confirmation message, transmitting payment credentials associated with a selected payment instrument of the consumer and required for conducting the pre-authorized transaction to the merchant or the acquirer of the merchant for use in completing the transaction; and in response to receiving a denial message, transmitting a denial notification to the merchant or the acquirer of the merchant.

The computer-readable medium may be a non-transitory computer-readable medium, the computer-readable program code being executable by a processing circuit.

In order for the invention to be more fully understood, implementations thereof will now be described with reference to the accompanying drawings.

### BRIEF DESCRIPTION OF THE DRAWINGS

FIG. 1A is a schematic drawing illustrating an embodiment of a system for conducting pre-authorized financial transactions according to the invention;

FIG. 1B is a block diagram illustrating components of a security gateway of the system of FIG. 1A;

FIG. 1C is a block diagram illustrating components of an electronic device of the system of FIG. 1A;

FIG. 2 is a swim-lane flow diagram which illustrates a method of conducting a pre-authorized financial transaction according to the invention;

FIG. 3 shows exemplary token generation steps conducted according to the invention;

FIG. 4 is a swim-lane flow diagram illustrating cancellation of a pre-authorized financial transaction according to embodiments of the invention;

FIG. 5 is a swim-lane flow diagram illustrating steps conducted to modify financial instrument details according to embodiments of the invention;

FIG. 6 is a swim-lane flow diagram illustrating steps conducted to modify financial transaction details according to embodiments of the invention;

FIG. 7 illustrates a block diagram of a computing device that can be used in various embodiments of the invention; and

FIG. 8 illustrates a block diagram of a communication device that can be used in various embodiments of the invention.

### DETAILED DESCRIPTION WITH REFERENCE TO THE DRAWINGS

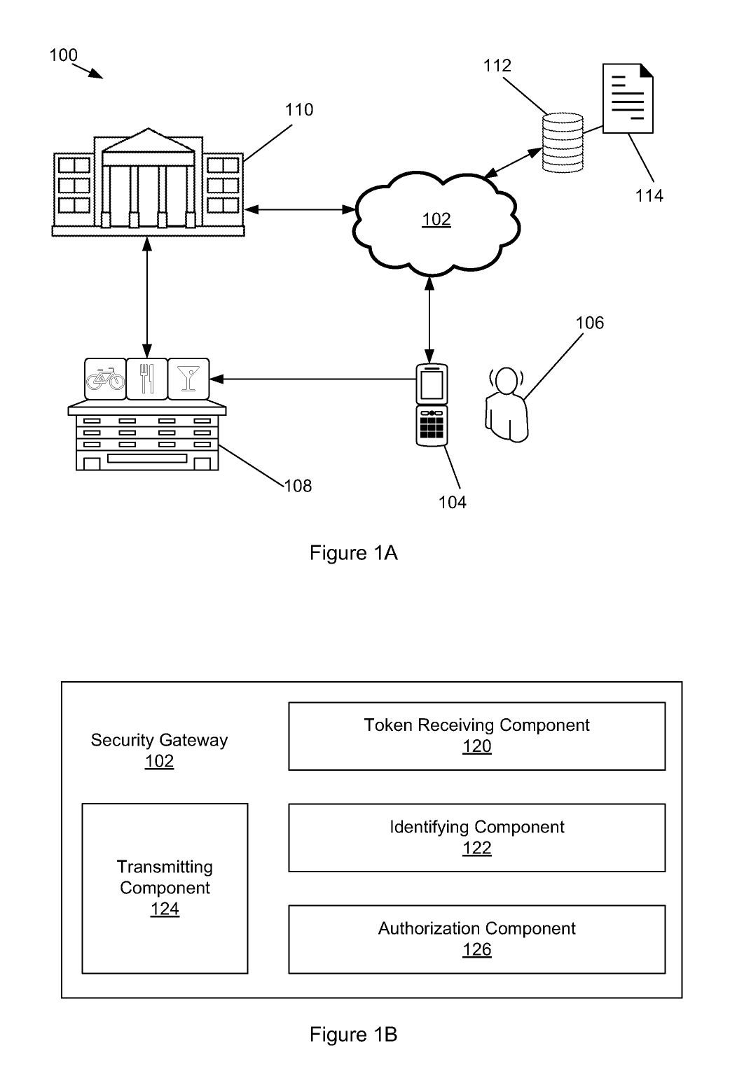

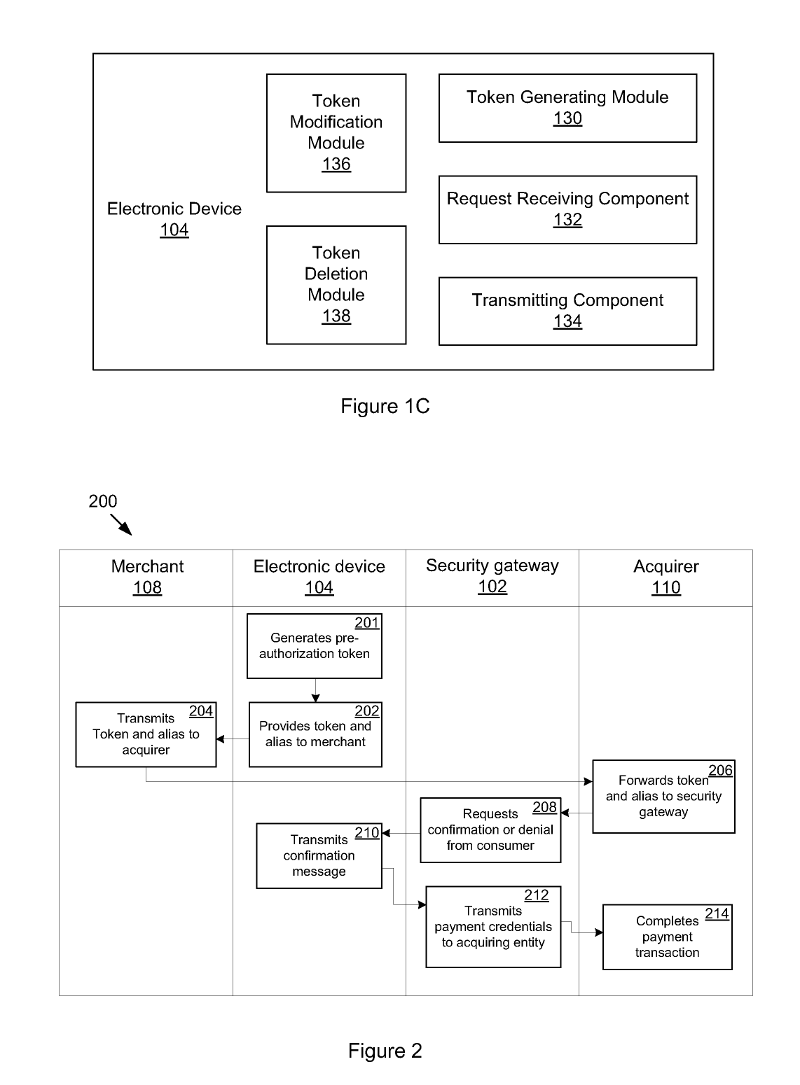

One embodiment of a system (100) for conducting pre-authorized financial transactions according to the invention is shown in FIG. 1A. The system (100) comprises a security gateway (102), an electronic device (104) of a consumer (106), a merchant (108), and an acquirer of the merchant (108). In this embodiment of the invention, the acquirer (110) is an acquiring bank.

The term “electronic device” should throughout this specification be interpreted so as to include any suitable communications device capable of communicating over a communications network, such as a cellular network, and having at least a limited amount of processing power. The term should be interpreted to specifically include all mobile or cellular phones but may also include portable computers such as laptops, handheld personal computers and the like. The electronic device may also have data storage devices such as a flash memory drive coupled thereto used for storing financial account-related or transactional data.

In the embodiment illustrated in FIG. 1A, the electronic device (104) of the consumer (106) is a mobile phone.

The security gateway (102) is linked to a database (112) which contains a plurality of consumer records (114). The database (112) may be integrated with the security gateway (102) or hosted external to the security gateway (102). Each consumer record (114) includes at least a consumer alias associated with a particular consumer and an identifier of an electronic device of the consumer, in order to match the alias with the electronic device of the consumer. This enables the security gateway (102), having received only the alias of the consumer (106), to identify and communicate with the corresponding electronic device (104).

In this embodiment, payment credentials of the consumer (106) are stored on the electronic device (104) in an encrypted format. The payment credentials are associated with a payment instrument of the consumer (106), for example, a payment card issued by an issuing bank of the consumer (106). The alias of the consumer (106) therefore acts as a reference to the payment credentials of the consumer (106) which are stored on the electronic device (104). In embodiments where the electronic device is, for example, a laptop computer, the electronic device may have a flash memory drive coupled thereto which stores the payment credentials in an encrypted format.

The security gateway (102) may, for example, be one or more server computers in communication with the electronic device (104), the acquirer (110) and/or the merchant (108). In the embodiment of FIG. 1A, communication between the electronic device (104) and the security gateway (102) and between the security gateway (102) and the acquirer (110) is encrypted and end-to-end secure. Communication between the electronic device (104) and the security gateway (102) may take place over any suitable channel, for example a mobile communications network, while communication between the security gateway (102) and the acquirer (110) may take place over any suitable channel, typically a wireless communication channel such as the Internet.

An embodiment of the security gateway (102) includes a token receiving component (120), an identifying component (122), a transmitting component (124) and an authorization component (126). These components are schematically illustrated in FIG. 1B.

The token receiving component (120) is configured to receive a pre-authorization token and a consumer alias from the merchant (108) or the acquirer (110), the token and alias having been provided to the merchant (108) by the consumer (106), optionally using the electronic device (104). The identifying component (122) is configured to identify an electronic device corresponding to the alias. The electronic device (104) is identified by matching the alias with an alias stored in association with a particular consumer record in the database (112), as described above with reference to FIG. 1A.

The security gateway (102) is capable of transmitting, by way of the transmitting component (124), requests and notifications to both the electronic device (102) and the merchant (108) or acquirer (110), as the case may be. The authorization component (126) is configured to receive confirmation or denial notifications from the electronic device (104) such that the security gateway (102) may authorize completion of a pre-authorized financial transaction.

In this embodiment, the security gateway (102) is provided by a payment processing network (not shown). The payment processing network may include data processing subsystems, networks, and operations used to support and deliver authorization services, exception file services, and clearing and settlement services. Payment processing networks, for example, VisaNet™, are able to process credit card transactions, debit card transactions, and other types of commercial transactions. Furthermore, the payment processing network may include one or more servers and may use any suitable wired or wireless network, including the Internet.

It should be appreciated that the security gateway (102) may equally be provided and/or hosted by the issuing bank of the consumer (106), or, alternatively, by an issuer-processor entity which acts both as an issuer and as a gateway connection to a payment processing network and/or acquiring entities.

To perform the functions described throughout the specification, an embodiment of the electronic device (104) of the consumer (106) may include a token generating module (130) for generating the pre-authorization token such that the consumer (106) is capable of providing the token to the merchant (108), a request receiving component (132) for receiving authorization requests from the security gateway (102), and a transmitting component (134) for transmitting either a confirmation message or a denial message in response to the authorization request. These components are schematically illustrated in FIG. 1C.

The electronic device may additionally include a token modification module (136) for altering details of the financial transaction identified by the pre-authorization token, and may include a token deletion module (138) for cancelling the financial transaction. The modification module (136) and deletion module (138) may be employed either prior to or after the pre-authorization token has been provided to the merchant (108) in order to permit modification or cancellation of the financial transaction. All or some of this functionality may be provided by a software application resident on the electronic device (104).

The system (100) described with reference to FIGS. 1A, 1B and 1C enables pre-authorized financial transactions to be conducted, cancelled and/or modified. The financial transaction to be conducted may be any suitable transaction, and is described as a payment transaction with reference to FIGS. 2 to 6. The exemplary descriptions which follow are non-limiting and are described as payment transactions conducted between a consumer and a merchant primarily for illustrative purposes.

The flow diagram (200) of FIG. 2 illustrates a series of steps performed in the system (100) of FIGS. 1A to 1C for conducting a pre-authorized financial transaction.

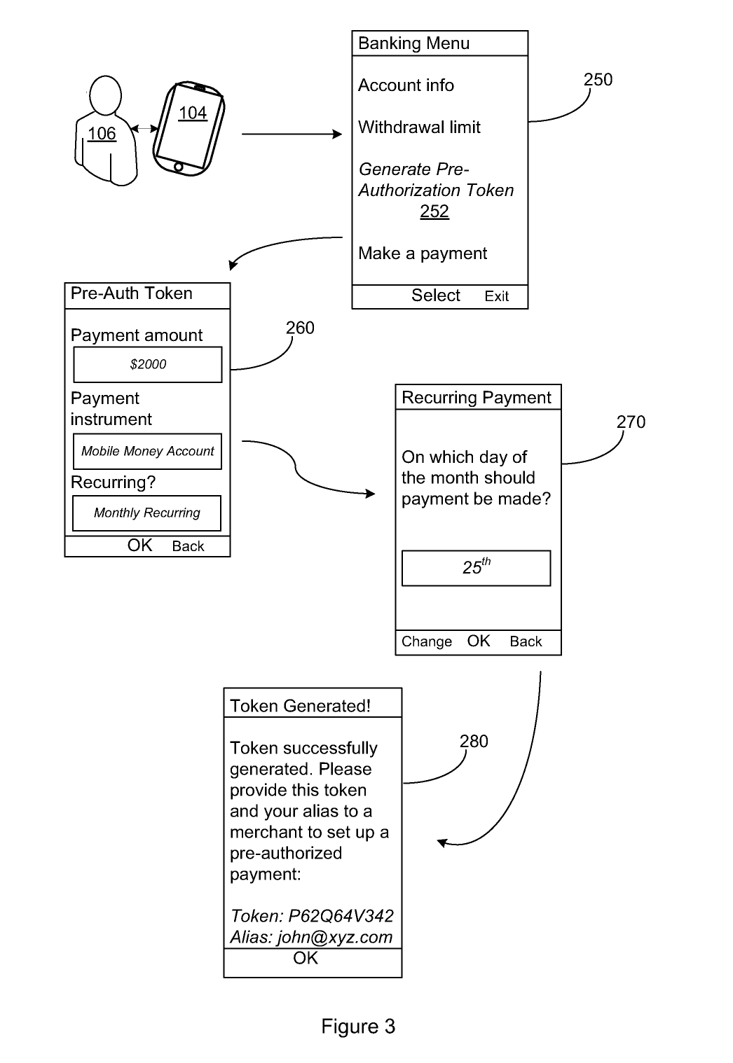

At a first stage (201), a pre-authorization token is generated by the consumer (106) using the electronic device (104). The token may be generated using the token generating module (130) of the electronic device (104). The token may be generated by any suitable means such that the consumer (106) is capable of providing the token and the alias to the merchant (108) for onward transmission to the security gateway (102). An exemplary token generation process is described below with reference to FIG. 3.

In this embodiment, the pre-authorization token is generated by way of a software application resident on the electronic device (104). The pre-authorization token uniquely identifies a pre-authorized financial transaction, in this embodiment a pre-authorization instruction for the payment transaction, and typically includes information such as a payment amount, a date of payment, merchant information, and payment frequency. In another embodiment, the pre-authorization token may be generated using a secure website of an issuing bank or other financial service provider.

Such information may be indicated on the pre-authorization token in human-readable form, encoded into the token, or the token may act as a reference which the security gateway and/or the acquirer may use to identify necessary transaction details. In a preferred embodiment, the pre-authorization token is simply a code which uniquely identifies the payment transaction and the details thereof, for example, a payment amount, a date of payment, details of the merchant (108), a selected payment instrument, and/or the frequency of the payment transaction if the transaction has a recurring nature. The token could, for example, be a six digit code or an eight digit code, the security gateway (102) being capable of identifying details required for conducting the transaction upon receipt of the code.

The payment transaction may be a once-off payment or a recurring payment. Therefore, the token may be used to pre-authorize transactions such as direct debits, mail or telephone order transactions, or point-of-sale (POS) transactions. In cases where the financial transaction is a recurring payment, the pre-authorization token preferably remains valid for each recurring payment.

In this embodiment, the financial transaction is a recurring direct debit transaction in which the acquirer (110) withdraws funds in favor of the merchant (108) from a financial account of the consumer (106) associated with a selected payment instrument.

At a next stage (202), the pre-authorization token and the alias are provided to the merchant (108) in order to pre-authorize a payment. In this embodiment, the token and alias are personally communicated to the merchant (108) by the consumer (106) in order to pre-authorize a payment transaction to be conducted in favour of the merchant (108).

An alias and token is provided to the merchant (108) in order to eliminate the need for the consumer (106) to present payment credentials, such as a bank identification number (BIN), a primary account number (PAN), a card verification value (CVV) number, an expiration date, and a cardholder name or a service code, to the merchant (108). Additionally, this may even eliminate the need for the consumer to provide other sensitive personal data, such as a residential address, to the merchant.

The alias is uniquely associated with the electronic device (104) and/or the consumer (106), and may, for example, be a Mobile Subscriber Integrated Services Digital Network Number (MSISDN) of the electronic device (104), an e-mail address of the consumer (106), a uniquely selected name, a uniquely selected identification number, or any other unique set of personal information of the consumer (106) which enables the security gateway (102) to identify the electronic device (104) upon receiving the alias.

At a next stage (204), the merchant (106), after receiving the token and the alias, transmits the token and the alias to the acquirer (110). When the payment is due, at a next stage (206), the acquirer (110) forwards the alias and the token to the security gateway (102). The acquirer may, in other embodiments, provide the alias and token to the security gateway at any other time with a request to initiate the financial transaction at a particular future data. The merchant may, alternatively, provide the alias and token directly to the security gateway without it being provided to the acquirer.

The security gateway (102) receives the token and the alias at the token receiving component (120). The security gateway (102) may then use the identifying component (122) to identify the electronic device (104) of the consumer (106) corresponding to the received alias and, in this embodiment, proceeds to transmit an authorization request to the electronic device (104) at a next stage (208). The security gateway (102) identifies the electronic device (104) corresponding to the alias received by retrieving the corresponding record (114) stored in the database (112).

The authorization request is sent to the electronic device (104) using the transmitting component (124) and prompts the consumer (106) to confirm or deny the pre-authorized transaction identified by the token received at the security gateway (102). The authorization request may be received at the request receiving component (132) of the electronic device (104).

The consumer (106) may have specifically opted to receive an authorization request if the amount to be paid is greater than a specified amount, or may have opted to receive an authorization request for any financial transaction. It should therefore be understood that the authorization request received from the security gateway (102) at the electronic device (104) may in some cases prompt the consumer (106) to confirm or deny the pre-authorized transaction. In other cases, authorization requests may be confirmed or denied automatically according to a predefined authorization setting. In such a case, in order to determine whether to transmit a confirmation message or a denial message in response to the authorization request, the electronic device (104) may use a predefined authorization setting which may have been provided to the device (104) by input of the consumer (106), such as to allow transactions from a certain merchant or to allow transactions having certain values, or any other suitable rule or condition. The electronic device (104) will then generate a confirmation message or a denial message in accordance with the predefined authorization setting.

The security gateway (102) may typically ascertain whether the pre-authorization token and the alias are valid or not expired, before transmitting the authorization request to the electronic device (104). It should be noted that the merchant (108) may also contact the security gateway (102) to ascertain whether or not the pre-authorization token is valid before providing the token to the acquirer (110).

Typically, the consumer (106) is presented with details of the payment transaction and is requested to confirm or deny the payment transaction using the electronic device (104). The consumer (106) may, for example, be presented with one or more of the amount to be paid, a selected payment instrument, merchant information, a payment date or dates, and payment frequency before allowing the payment transaction to be processed.

Once the consumer (106) is satisfied with the details described above or any other details involved, the consumer sends a confirmation message to the security gateway (102) at a next stage (210) using the transmitting component (134) of the electronic device (104). The authorization component (126) of the security gateway (102) is used to receive either the confirmation message or a denial message from the electronic device (104).

In cases where the consumer may possess more than one payment instrument usable in conducting the transaction, the confirmation message may serve to indicate the payment instrument to be used for the particular transaction.

Furthermore, the confirmation message may also include payment credentials necessary to complete the payment transaction. The payment credentials are associated with the selected payment instrument of the consumer, such as a debit account or a credit account. In one embodiment, the selected payment instrument represents a mobile banking account of the consumer (106) provided by an issuing bank, also referred to as a “mobile wallet” or “mobile money account”.

In this embodiment of the invention, the payment credentials are stored on the electronic device (104). Alternatively, the payment credentials may have be sent to the security gateway (102) at an earlier stage, or may be stored remotely at the security gateway (102) or issuer, obviating the need to store the payment credentials on the electronic device (104).

In cases where the consumer (106) is not satisfied with the details of the financial transaction or simply wants to stop the payment transaction from taking place, the consumer (106) may send a denial message to the security gateway (102).

At a next stage (212), in response to receiving the confirmation message from the electronic device (104), the security gateway (102) uses the transmitting component (124) to transmit the payment credentials required for conducting the pre-authorized transaction to the acquirer (110) for use in completing the payment transaction. It should be noted that the merchant (108) may also receive the payment credentials from the security gateway (102) and forward them to the acquirer (110). It is envisaged that an audited control standard may preferably be in place to ensure that neither the acquirer (110) nor the merchant (108) ever store these payment credentials.

The acquirer (110) may then use the payment credentials to complete the pre-authorized payment transaction at a final stage (214). Completion of the payment transaction typically results in a bank account held by the consumer (106) being debited and a bank account held by the merchant (108) being credited. It should be appreciated that in the case of a recurring payment transaction, the pre-authorization token would remain valid in order for it to be used multiple times. In the case of a once-off payment, however, the token would become invalid after the payment transaction is completed. This may be effected by updating the consumer record (114) in the database (112) to indicate that a particular token has been successfully used.

In response to receiving a denial message from the electronic device (104) of the consumer (106), the security gateway (102) may typically transmit a denial notification to the merchant (108) or the acquirer (110) using the transmitting component (124) to inform one or both of these entities that the pre-authorized transaction has been cancelled and will not be completed.

In alternative embodiments, the consumer (106) may have opted to automatically allow payments corresponding to a specific pre-authorization token. In such a case, the consumer (106) may provide predetermined payment credentials to the security gateway (102) and the payment transaction may take place without the security gateway (102) requesting a confirmation thereof from the consumer (106). The security gateway (102) may then be configured to automatically provide the payment credentials to the acquirer (110) upon receipt of a valid alias and a corresponding token from the acquirer (110).

In one example, the consumer (106) may wish to pre-authorize a point-of-sale (POS) transaction. In this case, the pre-authorization token will identify at least the payment amount and a selected payment instrument. If a POS device is not capable of accepting an alias, a one-time or single-use PAN may be generated and provided to the merchant (108) along with the pre-authorization token, or the token may be generated in the form of a single-use PAN. The PAN may be presented to the merchant (106) without compromising any static payment credentials of the consumer (106), such as a PAN or other account number of the consumer.

In the case where the pre-authorized transaction is a recurring direct debit, the token and the alias are presented to the merchant (108) once, with the token remaining valid until a predetermined number of payments have been made, or until the consumer (106) disables the pre-authorization token.

Embodiments of the invention provide for the payment credentials of the consumer (106) to be stored in an encrypted format on a secure element associated with the electronic device (104).

In a preferred embodiment, the secure element is a hardware security module (HSM) or a device including a HSM. The secure element may be a HSM embedded in the electronic device or a removable HSM. Furthermore, the secure element may be provided in a Universal Integrated Circuit Card (UICC) of the device (104).

In one embodiment, the HSM is attached to a communication component of the electronic device, such as a Subscriber Identity Module (SIM). In such a case, the HSM is part of a cryptographic expansion device which includes a public processing unit and a secure processing unit, the secure processing unit being accessible by the communication component and/or the electronic device only through the public processing unit.

The cryptographic expansion device may be attached to a communication component, such as a SIM card, of the electronic device, to enable the electronic device to perform cryptographic operations on communications sent to and from the electronic device. The cryptographic expansion device may include embedded processors and storage capabilities that can be used to implement a Federal Information Processing Standards (FIPS) HSM to provide the communication device with the set of security features and functions as found in industry-standard HSMs. Data, particularly the payment credentials of the consumer, may be stored securely on the cryptographic expansion device.

In at least one embodiment, therefore, communication between the security gateway (102) and the electronic device (104) may occur in the form of encrypted messages to and from the HSM of the electronic device (104). It should be appreciated that the security gateway may communicate with the electronic device and the acquiring bank in any other suitable manner, and that the payment credentials may be stored using a variety of other methods without departing from the scope of the invention.

It should be appreciated that more than one set of payment credentials may be available for use by the consumer in conducting the pre-authorized transaction. These sets may be stored on the electronic device, a HSM, or remotely as described above. Each set of payment credentials may correspond to a different payment instrument of the consumer. In embodiments of the invention, the consumer is capable of using the electronic device to select which payment instrument to link to the pre-authorization token.

Exemplary token generation steps are illustrated in FIG. 3. In this example, the consumer (106) accesses a mobile banking menu (250) of a banking application resident on the electronic device (104). At an initial stage (252), the consumer (106) selects the “Generate Pre-Authorization Token” option indicated on the mobile banking menu (250).

The consumer (106) then, at a next stage (260), enters a payment amount and a payment instrument to use, and indicates that the transaction is to be a monthly recurring payment. The selected payment instrument in this example is a mobile money account of the consumer (106). At a next stage (270), the consumer opts to have the payment made on the twenty-fifth day of each month.

At a final stage (280), a generated pre-authorization token is displayed along with the alias of the consumer (106), and the consumer (106) is instructed to provide the token and the alias to a merchant to set up a pre-authorized payment.

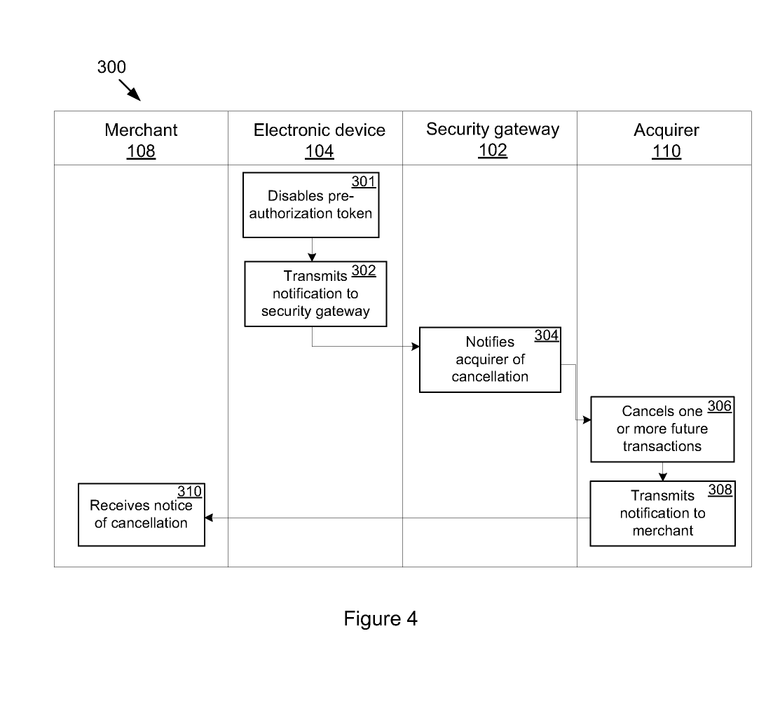

To cancel a payment transaction scheduled to take place either automatically or as described with reference to FIG. 2, the consumer (106) may cancel the payment transaction by using the electronic device (104) to delete or disable the pre-authorization token. The flow diagram (300) of FIG. 4 illustrates a series of steps in a method performed in the system (100) of FIG. 1A to cancel a pre-authorized payment transaction.

At a first stage (301), the consumer (106) cancels the payment transaction by using the electronic device (104) to delete or disable the pre-authorization token. This may be done, for example, using a software application or a secure website. The consumer (106) may typically provide input to the electronic device (104) such that it receives, at the token deletion module (138), an instruction to cancel the financial transaction.

The electronic device (104) then, at a next stage (302), transmits a notification of the payment cancellation to the security gateway (102). Communication between the electronic device (104) and the security gateway (102) may take place over any suitable communication channel, such as Unstructured Supplementary Service Data (USSD) or the Internet. This notification may be sent as an encrypted message from the HSM of the electronic device (104). It should be appreciated, however, that the electronic device (104) may communicate with the security gateway (102) in any other suitable manner.

The notification may take the form of a request, sent via the transmitting component (134) of the electronic device (104), prompting the security gateway (102) to cancel the financial transaction or a series of recurring financial transactions. At a next stage (304), the security gateway (102) cancels the transaction and notifies the acquirer (110) that the single or recurring payment transaction has been cancelled by the consumer (106). In cases where the acquirer (110) has not been notified of the future transaction, the merchant (108) may equally be notified of the cancellation.

At a next stage (306), the acquirer (110) cancels the future transaction or transactions to ensure that it does not prompt the security gateway (102) for the payment credentials of the consumer (106) on the payment date previously agreed upon.

In a preferred embodiment, the acquiring entity (110) sends a cancellation notification to the merchant (108) at a next stage (308). At a final stage (310), the merchant (108) receives the notification indicating that the pre-authorized transaction has been cancelled. It is foreseen that such a notification may also be sent to the merchant (108) and/or to the electronic device (104) of the consumer (106) directly from the security gateway (102).

It is foreseen the payment cancellation may only be communicated from the electronic device (104) to the security gateway (102) when the payment is scheduled to occur, as illustrated in FIG. 2. In such a situation, no further cancellation steps need to be performed after the initial stage (301).

In embodiments of the invention, the consumer is further capable of using the electronic device to transmit a request to alter details of the financial transaction to the security gateway. The security gateway may then alter details of the financial transaction based on the request received from the electronic device of the consumer.

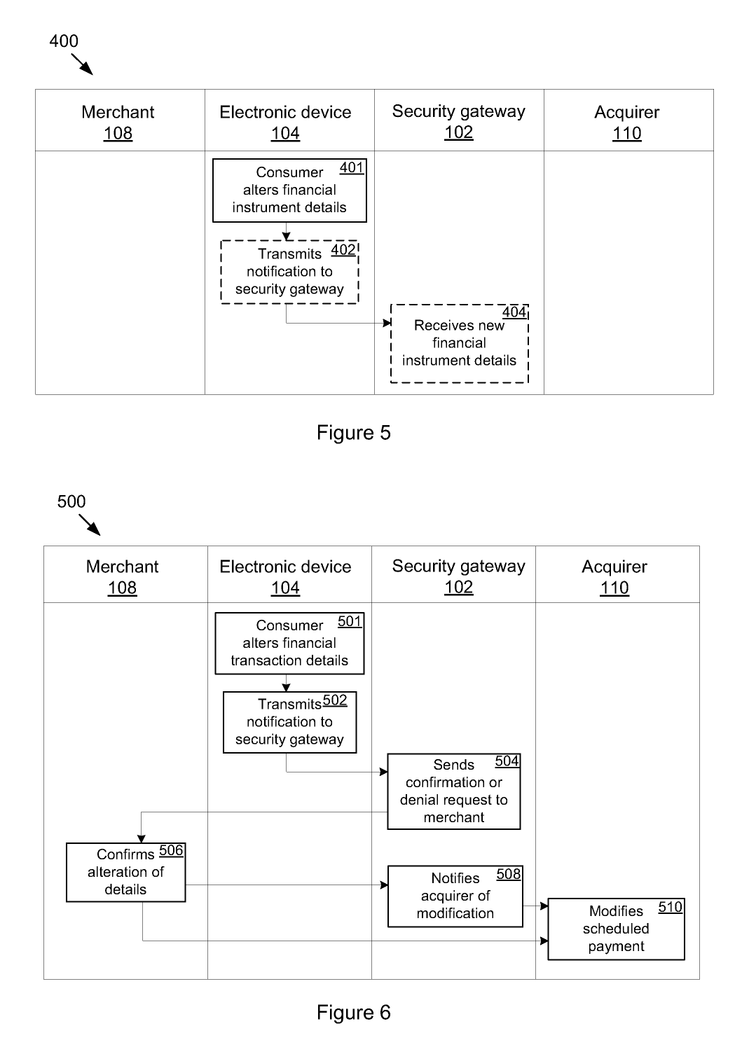

To modify details of a payment transaction scheduled to take place automatically as described with reference to FIG. 2, the steps illustrated in either FIG. 5 or FIG. 6 may be followed.

The flow diagram (400) of FIG. 5 illustrates a series of steps in a method performed to modify details of a selected financial instrument to be used for the payment transaction. The consumer (106) may, for example, wish to use a different set of payment credentials, in other words, a different payment instrument to a payment instrument that was initially agreed upon to perform the payment. In such cases, the merchant (108) need not be notified of the changes, because the payment credentials were not provided to or captured by the merchant (108) and the pre-authorization token remains valid in its existing format.

At a first stage (401), the consumer (106) uses, for example, a software application or a secure website to select an alternative set of payment credentials for the payment transaction. The consumer (106) may, for example, prefer to use a credit card instead of a debit card, as initially indicated, to perform the payment transaction. The consumer (106) is therefore, in such cases, capable of using the electronic device to select which payment instrument to link to the pre-authorization token and of changing such selection at any time prior to the processing of the actual transaction.

The consumer (106) may typically provide input to the electronic device (104) such that it receives, at the token modification module (136), an instruction to alter details of the financial transaction such as a selected payment instrument.

If the security gateway (102) is configured to transmit an authorization request to the electronic device (104) prompting the consumer (106) for a confirmation or denial message on the date of payment, no further steps may occur, because the new financial instrument details are only released to the security gateway (102) when the payment is scheduled to occur, as illustrated in FIG. 2.

As indicated by the broken lines in FIG. 5, two further steps may be carried out in the case of a payment transaction being scheduled to take place without requesting confirmation from the consumer. At a next stage (402), a notification of the modification is sent from the electronic device (104) to the security gateway (102). The notification may typically be sent as an encrypted message from the HSM of the electronic device (104) if it includes a set of new payment credentials. Alternatively, the notification may simply serve to link the pre-authorization token to a different set of payment credentials which are already stored at the security gateway or issuer.

At a final modification stage (404), the security gateway (102) receives the new financial instrument details. These details will be used to provide payment credentials corresponding to a newly selected financial instrument to the acquirer (110) when the acquirer (110) provides the valid token and corresponding alias for the payment transaction to the security gateway (102).

This feature allows the consumer (106) to modify the payment credentials under the pre-authorization instruction without changing the pre-authorization itself. In this way the consumer (106) may, for example, switch to a new bank without needing to inform the merchant (108) or the merchant's acquirer (110), due to the token and alias remaining remain valid for the pre-authorized transaction.

In certain cases it may be desirable for the consumer (106) to modify other details of the payment transaction before it takes place, such as the payment amount and the payment date. For these and other changes, confirmation or authorization of the change may typically be required from the merchant (108), whereas such confirmation or authorization may not be necessary when only a payment instrument is changed. The flow diagram (500) of FIG. 6 illustrates a series of steps performed to modify such details of a pre-authorized transaction according to the invention prior to it taking place.

At a first stage (501), the consumer (106) uses, for example, a software application or a secure website to request changes to details such as the payment amount, the payment date, or the frequency of the payments, in the case of a recurring payment transaction. The consumer (106) may, for example, prefer to have a direct debit take place on the first day of each month instead of on a day previously specified to the merchant (108).

At a next stage (502), the request is transmitted to the security gateway (102), which then transmits a confirmation or denial request to the merchant (108) at a further stage (504). If the merchant (108) is satisfied with the proposed change, the merchant (108), at a next stage (506), transmits a confirmation message to the security gateway (102). The security gateway (102) and/or the merchant (108) notifies the acquirer (110) of the changes associated with the pre-authorization token and alias at a next stage (508). The acquirer (110) then, at a final stage (510) updates the details of the scheduled transaction corresponding to the original pre-authorization token and alias.

This allows the consumer (106) to modify details such as the payment date, payment amount or frequency of payments without needing to physically visit the merchant (108) or the acquirer (110), generate a new pre-authorization token or cancel the original pre-authorization token.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

It should, for example, be noted that the payment credentials may be stored on any suitable device, preferably a secure device such as the HSM-enabled mobile device described above. Any other suitable HSM-enabled device, such as a flash memory drive having an HSM and being coupled to a laptop computer, may be employed to securely store payment credentials.

Alternatively, the payment credentials may be stored on the electronic device without using a HSM. In such a case, relatively strong software encryption may be used such as secure element capabilities provided on certain mobile operating systems, for example, certain Android operating systems.

It is envisaged that cancellation or denying of a pre-authorized transaction may involve cancelling or denying a single, once-off transaction, cancelling or denying one or more out of a larger series of recurring transactions, or cancelling or denying all future recurring transactions scheduled to take place.

The invention provides a system and method which may be used to eliminate or reduce the need for a consumer to present payment credentials to a merchant when setting up a future payment, particularly a recurring direct debit as herein defined. Furthermore, the process of altering details of a pre-authorized payment or cancelling a pre-authorized payment may be simplified or expedited. Importantly, details of the transaction may be modified or the transaction may be cancelled after the consumer has provided the token to the merchant.

The invention replaces the conventional step of provisioning actual payment credentials to a merchant with the provisioning of a reference to the credentials, thus separating payment instruments from the authorization to deduct funds. The pre-authorization token provided to the merchant is linked to payment credentials, which obviates the need to provide such credentials to the merchant. This may reduce the risk of fraudulent activities on the part of any entity with access to the credentials, at least to some extent.

The consumer may choose to use a different financial instrument for the payment at any time before the payment is scheduled to take place, thereby enhancing control and flexibility in which instrument to use. Furthermore, the consumer may request the merchant to accept modifications to payment details without needing to visit the merchant or generate a new pre-authorized payment token.

It is envisaged that the security gateway may be provided by an issuing bank of the consumer or any other entity issuing a bank account or banking product. The issuer may then be equipped with a single database and gateway wherein pre-authorization tokens are mapped to particular details of future transactions, such as which payment instrument to use for completing each transaction. The consumer may be capable of deleting or disabling a pre-authorized transaction by breaking the “link” between a specific token and a financial instrument so as to prevent the transaction from being completed. The consumer may also be capable of selecting a different payment instrument to use for the transaction by linking the pre-authorization token to a different payment instrument at the security gateway and/or database.

It is envisaged that the invention may reduce the risk of a merchant debiting a consumer's account inappropriately, because the consumer may request to be presented with the payment amount before confirming the payment.

Due to the fact that a recurring or a once-off payment may be pre-authorized, the transaction may be classified as a “card present transaction”. Interchange fees or other banking fees might be significantly lowered by such a classification.

It should be appreciated that the scope of the invention extends to a computer program product for conducting pre-authorized financial transactions. The computer program product may comprise a computer-readable medium having stored computer-readable program code for performing the steps of: receiving a pre-authorization token and a consumer alias from a merchant or an acquirer of the merchant, the pre-authorization token identifying a pre-authorized financial transaction and the token and alias having previously been provided to the merchant by a consumer; identifying an electronic device of the consumer corresponding to the alias by matching the alias with an alias stored in association with a consumer record; transmitting an authorization request to the electronic device; receiving from the electronic device either a confirmation message or a denial message in response to the authorization request; in response to receiving a confirmation message, transmitting payment credentials associated with a selected payment instrument of the consumer and required for conducting the pre-authorized transaction to the merchant or the acquirer of the merchant for use in completing the transaction; and in response to receiving a denial message, transmitting a denial notification to the merchant or the acquirer of the merchant. Such a computer-readable medium may be a non-transitory computer-readable medium, and the computer-readable program code may be executable by a processing circuit.

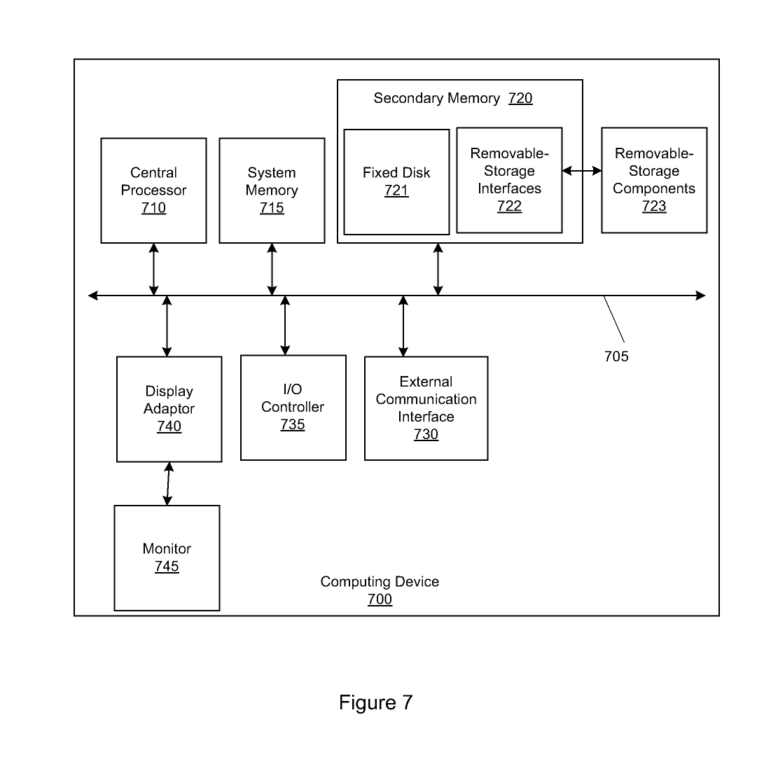

FIG. 7 illustrates an example of a computing device (700) in which various aspects of the disclosure may be implemented. The computing device (700) may be suitable for storing and executing computer program code. The various participants and elements in the previously described system diagrams may use any suitable number of subsystems or components of the computing device (700) to facilitate the functions described herein.

The computing device (700) may include subsystems or components interconnected via a communication infrastructure (705) (for example, a communications bus, a cross-over bar device, or a network). The computing device (700) may include at least one central processor (710) and at least one memory component in the form of computer-readable media.

The memory components may include system memory (715), which may include read only memory (ROM) and random access memory (RAM). A basic input/output system (BIOS) may be stored in ROM. System software may be stored in the system memory (715) including operating system software.

The memory components may also include secondary memory (720). The secondary memory (720) may include a fixed disk (721), such as a hard disk drive, and, optionally, one or more removable-storage interfaces (722) for removable-storage components (723).

The removable-storage interfaces (722) may be in the form of removable-storage drives (for example, magnetic tape drives, optical disk drives, floppy disk drives, etc.) for corresponding removable storage-components (for example, a magnetic tape, an optical disk, a floppy disk, etc.), which may be written to and read by the removable-storage drive.

The removable-storage interfaces (722) may also be in the form of ports or sockets for interfacing with other forms of removable-storage components (723) such as a flash memory drive, external hard drive, or removable memory chip, etc.

The computing device (700) may include an external communications interface (730) for operation of the computing device (700) in a networked environment enabling transfer of data between multiple computing devices (700). Data transferred via the external communications interface (730) may be in the form of signals, which may be electronic, electromagnetic, optical, radio, or other types of signal.

The external communications interface (730) may enable communication of data between the computing device (700) and other computing devices including servers and external storage facilities. Web services may be accessible by the computing device (700) via the communications interface (730).

The external communications interface (730) may also enable other forms of communication to and from the computing device (700) including, voice communication, near field communication, Bluetooth, etc.

The computer-readable media in the form of the various memory components may provide storage of computer-executable instructions, data structures, program modules, and other data. A computer program product may be provided by a computer-readable medium having stored computer-readable program code executable by the central processor (710).

A computer program product may be provided by a non-transient computer-readable medium, or may be provided via a signal or other transient means via the communications interface (730).

Interconnection via the communication infrastructure (705) allows a central processor (710) to communicate with each subsystem or component and to control the execution of instructions from the memory components, as well as the exchange of information between subsystems or components.

Peripherals (such as printers, scanners, cameras, or the like) and input/output (I/O) devices (such as a mouse, touchpad, keyboard, microphone, joystick, or the like) may couple to the computing device (700) either directly or via an I/O controller (735). These components may be connected to the computing device (700) by any number of means known in the art, such as a serial port.

One or more monitors (745) may be coupled via a display or video adapter (740) to the computing device (700).

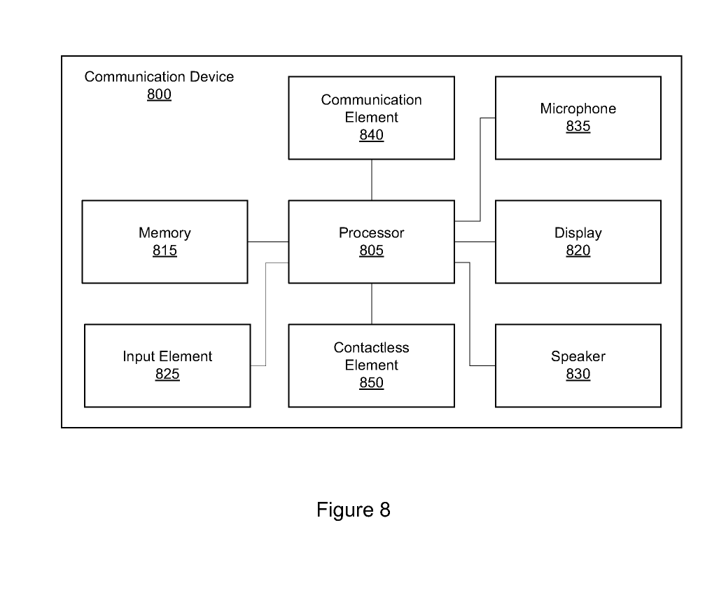

FIG. 8 shows a block diagram of a communication device (800) that may be used in embodiments of the disclosure. The communication device (800) may be a cell phone, a feature phone, a smart phone, a satellite phone, or a computing device having a phone capability.

The communication device (800) may include a processor (805) (e.g., a microprocessor) for processing the functions of the communication device (800) and a display (820) to allow a user to see the phone numbers and other information and messages. The communication device (800) may further include an input element (825) to allow a user to input information into the device (e.g., input buttons, touch screen, etc.), a speaker (830) to allow the user to hear voice communication, music, etc., and a microphone (835) to allow the user to transmit his or her voice through the communication device (800).

The processor (810) of the communication device (800) may connect to a memory (815). The memory (815) may be in the form of a computer-readable medium that stores data and, optionally, computer-executable instructions.

The communication device (800) may also include a communication element (840) for connection to communication channels (e.g., a cellular telephone network, data transmission network, Wi-Fi network, satellite-phone network, Internet network, Satellite Internet Network, etc.). The communication element (840) may include an associated wireless transfer element, such as an antenna.

The communication element (840) may include a subscriber identity module (SIM) in the form of an integrated circuit that stores an international mobile subscriber identity and the related key used to identify and authenticate a subscriber using the communication device (800). One or more subscriber identity modules may be removable from the communication device (800) or embedded in the communication device (800).

The communication device (800) may further include a contactless element (850), which is typically implemented in the form of a semiconductor chip (or other data storage element) with an associated wireless transfer element, such as an antenna. The contactless element (850) may be associated with (e.g., embedded within) the communication device (800) and data or control instructions transmitted via a cellular network may be applied to the contactless element (850) by means of a contactless element interface (not shown). The contactless element interface may function to permit the exchange of data and/or control instructions between electronic device circuitry (and hence the cellular network) and the contactless element (850).

The contactless element (850) may be capable of transferring and receiving data using a near field communications (NFC) capability (or near field communications medium) typically in accordance with a standardized protocol or data transfer mechanism (e.g., ISO 14443/NFC). Near field communications capability is a short-range communications capability, such as radio-frequency identification (RFID), Bluetooth, infra-red, or other data transfer capability that can be used to exchange data between the communication device (800) and an interrogation device. Thus, the communication device (800) may be capable of communicating and transferring data and/or control instructions via both a cellular network and near field communications capability.

The data stored in the memory (815) may include: operation data relating to the operation of the communication device (800), personal data (e.g., name, date of birth, identification number, etc.), financial data (e.g., bank account information, a bank identification number (BIN), credit or debit card number information, account balance information, expiration date, loyalty provider account numbers, etc.), transit information (e.g., as in a subway or train pass), access information (e.g., as in access badges), etc. A user may transmit this data from the communication device (800) to selected receivers.

The communication device (800) may be, amongst other things, a notification device that can receive alert messages and access reports, a portable merchant device that can be used to transmit control data identifying a discount to be applied, as well as a portable consumer device that can be used to make payments.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The software components or functions described in this application may be implemented as software code to be executed by one or more processors using any suitable computer language such as, for example, Java, C++, or Perl using, for example, conventional or object-oriented techniques. The software code may be stored as a series of instructions, or commands on a non-transitory computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

Any of the steps, operations, or processes described herein may be performed or implemented with one or more hardware or software modules, alone or in combination with other devices. In one embodiment, a software module is implemented with a computer program product comprising a non-transient computer-readable medium containing computer program code, which can be executed by a computer processor for performing any or all of the steps, operations, or processes described.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A method of conducting a pre-authorized financial transaction, the method carried out at a security gateway and comprising:
receiving a pre-authorization token and a consumer alias from a merchant or an acquirer of the merchant, the pre-authorization token identifying a pre-authorized financial transaction and the token and alias having previously been provided to the merchant by a consumer;
identifying an electronic device of the consumer corresponding to the alias by matching the alias with an alias stored in association with a consumer record;
transmitting an authorization request to the electronic device;
receiving from the electronic device either a confirmation message or a denial message in response to the authorization request;
in response to receiving a confirmation message, transmitting payment credentials associated with a selected payment instrument of the consumer and required for conducting the pre-authorized transaction to the merchant or the acquirer of the merchant for use in completing the transaction; and
in response to receiving a denial message, transmitting a denial notification to the merchant or the acquirer of the merchant.

2. A method as claimed in claim 1, wherein the pre-authorization token is generated by the electronic device of the consumer.

3. A method as claimed in claim 1, further comprising the steps of:
receiving a request from the electronic device to cancel the pre-authorized financial transaction identified by the pre-authorization token or to alter details of the financial transaction; and
either cancelling the financial transaction or altering details of the financial transactions based on the request received from the electronic device.

4. A method as claimed in claim 1, wherein the authorization request transmitted to the electronic device includes details of the financial transaction, including one or more of: a payment amount, a date of payment, merchant information, and a selected payment instrument.

5. A method as claimed in claim 1, wherein the financial transaction is a direct debit transaction in which the acquirer of the merchant withdraws funds in favor of the merchant from a financial account of the consumer associated with the selected payment instrument.

6. A method as claimed in claim 1, wherein the financial transaction is a recurring payment and wherein the pre-authorization token remains valid for each recurring payment.

7. A method as claimed in claim 1, wherein the confirmation message received from the electronic device of the consumer includes an instruction indicating a selected payment instrument.

8. A method as claimed in claim 1, wherein the confirmation message received from the electronic device of the consumer includes the payment credentials required for conducting the pre-authorized transaction.

9. A method as claimed in claim 1, wherein the selected payment instrument represents a mobile banking account.

10. A method of conducting a pre-authorized financial transaction, the method carried out at an electronic device of a consumer and comprising:
generating a pre-authorization token which identifies a pre-authorized financial transaction, the token being generated such that the consumer is capable of providing the token and a consumer alias to a merchant for onward transmission to a security gateway, the security gateway matching the alias with an alias stored in association with a consumer record to identify the electronic device of the consumer;
receiving an authorization request from the security gateway; and
transmitting to the security gateway either a confirmation message or a denial message in response to the authorization request.

11. A method as claimed in claim 10, wherein the authorization request received from the security gateway prompts the consumer to confirm or deny the pre-authorized transaction.

12. A method as claimed in claim 10, wherein the step of transmitting to the security gateway either a confirmation message or a denial message in response to the authorization request is preceded by the step of: using a predefined authorization setting to determine whether to confirm or deny the pre-authorized transaction, and generating a confirmation message or a denial message in accordance with the predefined authorization setting.

13. A method as claimed in claim 10, including the step of receiving, by input of the consumer, either an instruction to alter details relating to the financial transaction identified by the pre-authorization token or an instruction to cancel the financial transaction.

14. A method as claimed in claim 13, wherein the instruction to alter details relating to the financial transaction includes a selection of a payment instrument to link to the pre-authorization token.

15. A method as claimed in claim 13, wherein the instruction to alter details relating to the financial transaction or the instruction to cancel the financial transaction is received at the electronic device after the pre-authorization token has been provided to the merchant.

16. A method as claimed in claim 10, wherein payment credentials are stored on the electronic device in an encrypted format, the payment credentials being associated with a selected payment instrument of the consumer and required for conducting the pre-authorized transaction, and wherein the confirmation message includes the payment credentials.

17. A method as claimed in claim 16, wherein more than one set of payment credentials are stored on the electronic device, each set of payment credentials corresponding to a different payment instrument of the consumer.

18. A method as claimed in claim 10, wherein the electronic device is a mobile phone.

19. A system for conducting a pre-authorized financial transaction, comprising:
a security gateway including:
a token receiving component for receiving a pre-authorization token and a consumer alias from a merchant or an acquirer of the merchant, the pre-authorization token identifying a pre-authorized financial transaction and the token and alias having previously been provided to the merchant by a consumer;
an identifying component for identifying an electronic device of the consumer corresponding to the alias by matching the alias with an alias stored in association with a consumer record;
a transmitting component for transmitting an authorization request to the electronic device;
an authorization component for receiving from the electronic device either a confirmation message or a denial message in response to the authorization request;
and wherein, in response to receiving a confirmation message, the transmitting component transmits payment credentials associated with a selected payment instrument of the consumer and required for conducting the pre-authorized transaction to the merchant or the acquirer of the merchant for use in completing the transaction; and
in response to receiving a denial message, the transmitting component transmits a denial notification to the merchant or the acquirer of the merchant.

20. A system as claimed in claim 19, further comprising:
an electronic device of a consumer including:
a token generating module for generating the pre-authorization token such that the consumer is capable of providing the token to the merchant;
a request receiving component for receiving the authorization request from the security gateway; and
a transmitting component for transmitting either the confirmation message or the denial message to the security gateway in response to the authorization request.

21. A system as claimed in claim 20, wherein the electronic device further includes one or both of a token modification module for altering details of the financial transaction identified by the pre-authorization token and a token deletion module for cancelling the financial transaction, the token modification module and the token deletion module permitting the financial transaction to be respectively modified and cancelled after the pre-authorization token has been provided to the merchant.

22. A system as claimed in claim 20, wherein the payment credentials are stored in a secure element associated with the electronic device.

23. A system as claimed in claim 22, wherein the secure element is a hardware security module (HSM) or includes a HSM.

24. A system as claimed in claim 23, wherein the HSM is part of a cryptographic expansion device attached to a communication component of the electronic device, the HSM having a public processing unit and a secure processing unit, the secure processing unit being accessible by the communication component and/or the electronic device only through the public processing unit.

25. A computer program product for conducting pre-authorized financial transactions, the computer program product comprising a computer-readable medium having stored computer-readable program code for performing the steps of:
receiving a pre-authorization token and a consumer alias from a merchant or an acquirer of the merchant, the pre-authorization token identifying a pre-authorized financial transaction and the token and alias having previously been provided to the merchant by a consumer;
identifying an electronic device of the consumer corresponding to the alias by matching the alias with an alias stored in association with a consumer record;
transmitting an authorization request to the electronic device;
receiving from the electronic device either a confirmation message or a denial message in response to the authorization request;
in response to receiving a confirmation message, transmitting payment credentials associated with a selected payment instrument of the consumer and required for conducting the pre-authorized transaction to the merchant or the acquirer of the merchant for use in completing the transaction; and
in response to receiving a denial message, transmitting a denial notification to the merchant or the acquirer of the merchant.
